(19) United States
(12) Patent Application Publication
(10) Pub. No.: US 2003/0070181 A1
(43) Pub. Date: Apr. 10, 2003

(54) Interactive TV client device with integrated removable storage system

(76) Inventor: Russell Holm, Kent, WA (US)

Correspondence Address: DIGEO, INC C/O STOEL RIVES LLP, 201 SOUTH MAIN STREET, SUITE 1100, ONE UTAH CENTER, SALT LAKE CITY, UT, 84111, US

(21) Appl. No.: 09/971,066

(22) Filed: Oct. 4, 2001

(51) Int. Cl. H04N 7/16; H04N 7/173

(52) U.S. Cl. 725/134; 725/110; 725/109; 725/142; 725/25

(57) ABSTRACT

In one embodiment, an advanced set top box device comprises an integrated removable digital storage system coupled to a digital tuner that receives and demodulates signals received from a video casting network. In another embodiment, the removable digital storage device is integrated into an advanced television device. This invention overcomes the finite storage limitations of conventional systems and provides a user with much greater flexibility in managing the increasingly massive amount of content and data being received by way of interactive TV services. It also enables a user to view digital content on devices other than the one TV in a home that may be capable of receiving the content.

### BACKGROUND OF THE INVENTION

1. Field of the Invention

The present invention relates generally to electronics, and more particularly, to set top boxes for satellite or cable television services.

2. Description of the Background Art

With the advent of new TV services, the amount of signals and data transmitted to a set top box is increasing dramatically. Such signals and data include many broadcast channels of analog and digital video and digital music. It also includes data from interactive TV channels and the Internet.

The flood of information received from TV services creates a problem of how to manage all the signals and data. Currently, it is difficult for a person to manage the abundance of signals and data, in part, because present set top box equipment has only a limited amount of storage, if any, for such signals and data. For example, MOTOROLA's popular DCT-2000 digital set top boxes do not have any significant storage for such signals and data. More advanced digital set top box designs may plan to include a hard disk to store data, but inevitably the finite amount of storage available on a hard disk will become full when the hard disk is used to store hours of digital video programming. Similarly, personal video recorder (PVR) or digital video recorder (DVR) devices, such as the TIVO recorder product, include a hard disk which provides a finite amount of storage, but again such finite storage rapidly becomes full when storing hours of digital video. Furthermore, conventional systems tend to constrain use of downloaded signals and data to a TV environment. Portability of the video, music, and data is rather limited.

### BRIEF DESCRIPTION OF THE DRAWINGS

Non-limiting and non-exhaustive embodiments of the present invention are described in the Figures, in which

FIG. 1 is a schematic block diagram of a video casting network according to an embodiment of the invention;

FIG. 2 is a diagram of a first interactive television client system according to an embodiment of the invention;

FIG. 3 is a diagram of a first set top box according to an embodiment of the invention;

FIG. 4 is a diagram of a second set top box according to an embodiment of the invention;

FIG. 5 is a diagram of a second interactive television client system according to an embodiment of the invention; and

FIG. 6 is a flowchart of a method for digital data capture and storage according to an embodiment of the invention.

### DETAILED DESCRIPTION OF THE PREFERRED EMBODIMENTS

The present invention provides systems, devices, and methods for overcoming the above-described problems and limitations of current systems. In one embodiment of the invention, an advanced set top box device comprises an integrated removable digital storage system coupled to a tuner that receives and demodulates signals received from a video casting network. In another embodiment of the invention, the removable digital storage device is integrated into an advanced television device.

Embodiments of systems, methods, and devices relating to a removable storage system for interactive TV are described herein. In the following description, numerous specific details are provided, such as examples of programming, user selections, transactions, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

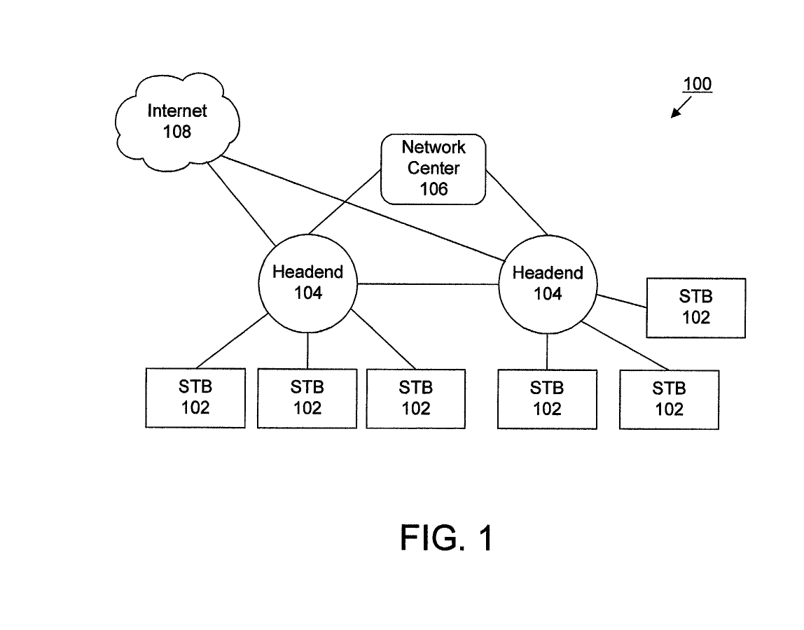

Referring now to FIG. 1, there is shown a video casting network 100, such as a cable network, according to an embodiment of the invention. In one implementation, the network 100 includes a plurality of set top boxes 102 (hereinafter STB 102) or other customer premises equipment (CPE) located, for instance, at customer homes. Generally, an STB 102 is consumer electronics device that serves as a gateway between a customer's television and a broadband communication network, such as a cable network. As its name implies, an STB 102 is typically located on top of, or in close proximity to, a customer's television.

In one embodiment, an STB 102 receives encoded video/audio signals (including television signals) from the network 100 and decodes the same for display on the television. Additionally, an STB 102 receives commands from a user (typically via a remote control) and transmits such commands back to the network 100.

In various embodiments, each STB 102 is connected to a headend 104. In the context of cable network, a headend 104 is a centrally-located facility where digital and analog cable TV (CATV) channels are received from a local CATV satellite downlink and packaged together for transmission to customer homes. In this way, a headend 104 functions as a local digital broadcast center.

Headends 104 may be coupled directly to one another or through a network center 106. In some cases, headends 104 may be connected via a separate network, one particular example of which is Internet 108. Of course, the illustrated network topology is provided for example purposes only, and other network topologies may be used within the scope of the invention.

As described in detail hereafter, each STB 102 may be identified by a unique number, code or address, such as an IP (Internet Protocol) address. Thus, a user of one STB 102 may indicate an STB 102 to receive an audio or video transmission by specifying the corresponding address. The network 100 then routes the transmission to its destination using conventional techniques.

Alternatively to the cable network, other video casting networks may be used in accordance with other embodiments of the invention. For example, satellite TV delivery systems may be used. A satellite TV delivery system may comprise a direct broadcast satellite (DBS) system. A DBS system may comprise a small 18-inch satellite dish (which is an antenna for receiving a satellite broadcast signal); a digital integrated receiver/decoder (IRD), which separates each channel, and decompresses and translates the digital signal so a television can show it; and a remote control. Programming for a DBS system may be distributed, for example, by multiple high-power satellites in geosynchronous orbit, each with multiple transponders. Compression (e.g., MPEG) is used to increase the amount of programming that can be transmitted in the available bandwidth.

A digital broadcast center may be used to gather programming content, ensure its digital quality, and transmit the signal up to the satellites. Programming may come to the broadcast center from content providers (CNN®, ESPN®, etc.) via satellite, fiber optic cable and/or special digital tape. Satellite-delivered programming is typically immediately digitized, encrypted and uplinked to the orbiting satellites. The satellites retransmit the signal back down to every earth-station—or, in other words, every compatible DBS system receiver dish at customers' homes and businesses.

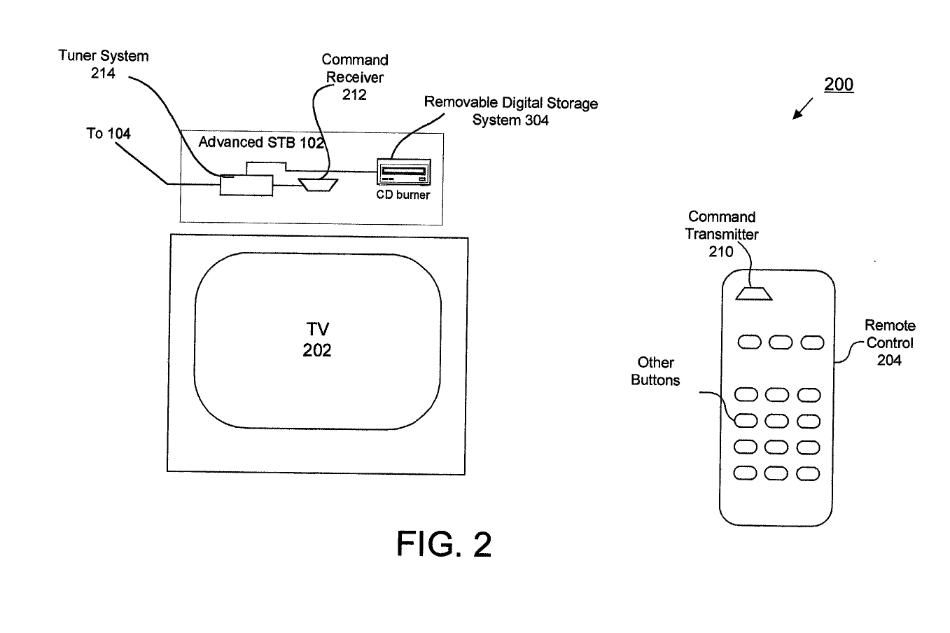

Referring now to FIG. 2, there is shown various components of an interactive television client system 200 according to an embodiment of the invention. The client system 200 preferably includes a television 202, which is configured to receive and display standard analog or digital television signals or high-definition television (HDTV) signals. In this embodiment, the client system 200 includes an advanced STB 102 with a tuner system 214 for receiving and demodulating video, audio, and other data from the network 100.

The tuner system 214 may include a digital tuner configured to tune to a digital channel of the video casting network 100. Such digital channels typically broadcast compressed digital video to set top boxes. The tuner system 214 may also include an analog tuner configured to tune to an analog TV channel of the video casting network and to extract an analog TV signal therefrom. Such an analog tuner system makes the STB 102 “backward compatible” with analog TV broadcasts. Alternatively, a different analog tuner system may be configured to tune to analog radio channel and to extract an analog radio signal therefrom. An encoder may be included to convert the analog TV (or radio) signal to digital data that may be saved by the removable storage system 304.

In one embodiment, a remote control 204 is provided for convenient remote operation of the advanced STB 102 and the television 202. The remote control 204 may communicate with the advanced STB 102 and television 202 using conventional techniques to adjust, for example, the volume of the television, the displayed channel, and the like. Such communication may occur, for example, by way of control codes being transmitted from a command transmitter 210 on the remote 204 to a command receiver 212 on the STB 102. The transmitter 210 and receiver 212 may comprise, for example, infrared or radio frequency communication devices.

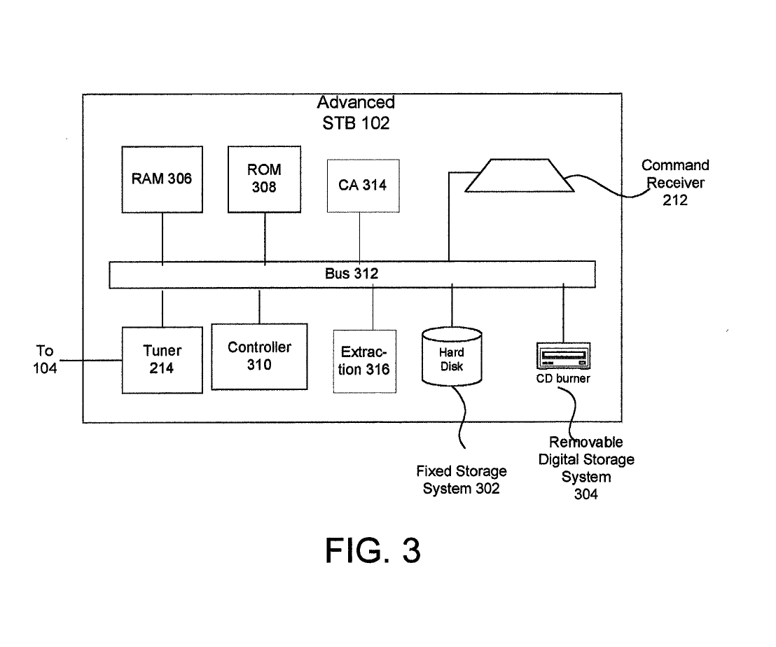

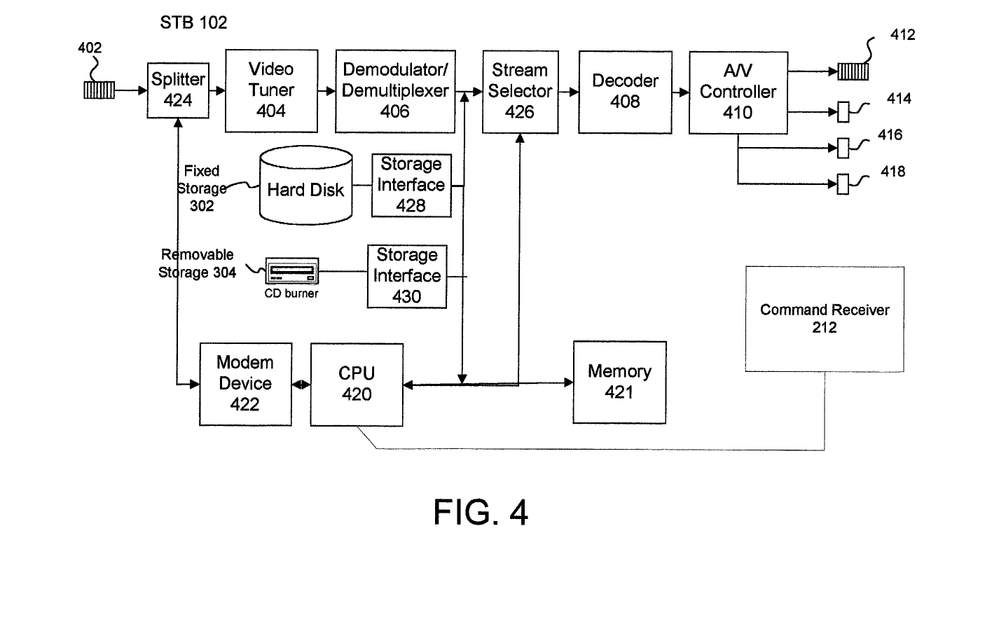

In accordance with an embodiment of the invention, the advanced STB 102 also comprises an integrated removable digital storage system 304. The removable digital storage system 304 may comprise a compact disc (CD) “burner” that enables data to be written onto CDs. The CD burner may provide write-once and/or rewritable capabilities. For example, the CD burner may store compressed digital audio files in the MP3 format onto CD media. Alternatively, the removable digital storage system 304 may comprise a digital video disc (DVD) burner that enables data to be written onto DVDs. The DVD burner may also provide write-once and/or rewritable capabilities. For example, the DVD burner may store compressed digital video files in a format compatible with one of the MPEG standards. In one embodiment, the removable digital storage system 304 may comprise a combination drive that includes both CD and DVD capabilities. Other removable digital storage systems may also be used. The integration of the removable digital storage system 304 into the STB 102 is illustrated in a simplified manner in FIG. 2. The integration of the removable digital storage system 304 into the STB 102 is described in detail below in relation to FIGS. 3 and 4.

Referring to FIG. 3, there is shown an expanded diagram of a first advanced STB 102 according to an embodiment of the invention. The STB 102 preferably includes a controller 310 that is in communication with the receiver 212, the tuner 214, a fixed digital storage system 302, a removable digital storage system 304, RAM 306, ROM 308, and conditional access (CA) system 314, and extraction system 316. The controller 310 may be coupled to the other components of the STB 102, for example, via a bus 312.

In various embodiments, the controller 310 may be embodied as a microcontroller, a microprocessor, a digital signal processor (DSP) or other device known in the art. The controller 310 manages the operation of the STB 102, including, for example, the transmission and reception of video/audio/data information from the network 100, the storage of the video/audio/data information, and the like. As noted above, the controller 310 may perform these and other operations based on control signals generated by the remote control 204 and transmitted to the receiver 212.

The STB 102 may further include a random access memory (RAM) 306 configured to store data for temporary use. Similarly, a read-only memory (ROM) 308 may be provided for storing more permanent data, such as fixed code and configuration information. In one embodiment, the ROM 308 may be used to store an operating system for the STB 102, such as the WINDOWS CE or LINUX operating systems.

In one embodiment, the STB 102 further comprises a conditional access (CA) system 314 coupled to the tuner system 214. The CA system 314 restricts channels accessible by the device to authorized channels only. The CA system 314 may be implemented using software and/or components available, for example, from MOTOROLA or SCIENTIFIC ATLANTA. A typical CA system 314 operates in cooperation with a corresponding CA server in a cable head-end 104.

The STB 102 shown in FIG. 3 also includes an extraction system 316. The extraction system 316 extracts digital data from the channel tuned to by the tuner 214. If the channel is an analog channel, then the extraction system 316 includes an encoder for converting the analog signal to digital data. If the channel is a digital channel, it would not be necessary to use such an analog-to-digital encoder. The digital data output by extraction system 316 may be of a form that is storable by the removable digital storage system 304. Alternatively, a format converter may be used to convert the digital data output by the extraction system 316 to a form that is storable by the removable digital storage system 304.

In addition, the STB 102 may include a cable modem (not shown in FIG. 3) coupled to the video casting network 100, typically coupling to the network 100 via the same RF cable as used to couple the tuner system 214 to the network 100. The cable modem is configured to receive digital data by demodulating an analog signal received from the network 100 and to transmit digital data by modulating the digital data to create an analog signal for transmission to the network 100. The cable modem may be implemented using, for example, the DOCSIS or DAVIC standards. A typical cable modem operates in cooperation with a cable modem termination system at a cable head-end 104.

The STB 102 may include a fixed digital storage system 302, such as a hard disk drive or the like. Such a fixed storage system 302 may be used, for example, to store digital video for later viewing by a user. However, the finite amount of storage available on the fixed storage system 302 will become full when it is used to store hours of digital video programming.

In accordance with an embodiment of the invention, the STB 102 comprises an integrated removable digital storage system 304. The removable digital storage system 304 may comprise a disc “burner” such as a compact disc (CD) burner that enables data to be written onto CDs. The CD burner may be configured, for example, to utilize an MP3 CODEC (compression-decompression algorithm) for storing audio and/or a MPEG-1 CODEC for storing video. Alternate CODECs may also be used. The CD burner may provide write-once and/or rewritable capabilities. Alternatively, the removable digital storage system 304 may comprise a digital video disc (DVD) burner that enables data to be written onto DVDs. The DVD burner may be configured, for example, to utilize an MPEG-2 CODEC for storing video. Alternate CODECs may also be used. The above-mentioned CODECs may be preferably implemented in hardware, but alternatively may be implemented in software (which tends to be slower than hardware). In one possible embodiment, an audio CODEC may be implemented in software to reduce costs, while a video CODEC may be implemented in hardware for purposes of speedier processing of the larger amount of video data. The DVD burner may also provide write-once and/or rewritable capabilities. In one embodiment, the removable storage system 304 may comprise a combination drive that includes both CD and DVD capabilities. Other removable digital storage systems may also be used. The removable digital storage system 304 may include a storage interface that couples the removable storage device (for example, the CD burner device) to the communications bus 312 shown in FIG. 3. In that manner, the removable digital storage system 304 becomes integrated with the STB 102.

Additional components may be included in the STB 102 to further enhance its capabilities and functionalities. For example, a format converter may be incorporated into the STB 102. The format converter may be implemented either in software or in hardware and may be used to convert digital data from one form (a first form) to another form (a second form) before the data is saved by the removable storage system 304. For example, the format converter may convert streaming audio or WAV files into a compressed digital format.

As another example, the STB 102 may include a copyright management system coupled to the removable digital storage system 304. The copyright management system may be implemented either in software or in hardware and may communicate with a copyright authorization center by way of the network 100. The copyright management system operates to restrict the digital data storable onto the removable digital storage media by the storage system 304.

Furthermore, in one embodiment of the invention, the memory of the STB 102 is configured with a jukebox module. The jukebox module may be implemented to be compatible, for example, with audio compressed in accordance with the MP3 and with video compressed in accordance with MPEG standards. The STB 102 with the integrated jukebox module provides capability for a user to customize a selection or compilation of audio or video and to burn them onto compact discs for storage or portability.

Referring now to FIG. 4, the second advanced STB 102 depicted therein includes an RF input 402, such as cable television “F” connector, for coupling the STB 102 to a cable head-end 104 or other distribution node of a video casting network. The RF input 402 is in electrical communication with a video tuner 404 for selectively receiving an analog signal ranging in frequency, for example, from 50 to 860 Mhz.

The signal may include a modulated/multiplexed digital media stream, such as an MPEG (Moving Picture Experts Group) or DIGICYPHER encoded stream used by MOTOROLA. The digital media stream may include a number of discrete audio/video “channels,” which may be selected by a user through the use of a remote control device (not shown). As used herein, the term “digital media stream” may include video and audio streams individually or collectively.

The video tuner 404 is coupled, in one implementation, to a demodulator/demultiplexer 406, which demodulates the signal and selects a particular audio/video channel for decoding by a hardware decoder 408 (such as an MPEG-2 decoder). The decoder 408 is typically a special-purpose hardware unit that is able to provide relatively high frame rates when compared to software decoding by a general-purpose microprocessor. Single-chip MPEG-2 decoders are well known and available from a number of manufacturers, such as Broadcom, LSI Logic, and the like. Likewise, video tuners 404 and demodulator/demultiplexers 406 are well known and available in the art.

Of course, those skilled in the art will recognize that various other MPEG standards exist, such as MPEG-1, MPEG-4, MPEG-7 and the like. Thus, the term “MPEG,” as used herein, is intended to encompass all of the MPEG video standards. Moreover, other video encoding/compression standards exist other than MPEG, such as DIGICYPHER encoding, JPEG, JPEG-LS, H.261, and H.263. Accordingly, the invention should not be construed as being limited only to MPEG.

The decoder 408 is coupled, in one embodiment, to an audio/video (AN) controller 410. The AN controller 410 provides audio/video output suitable for reception by a television. The AN controller 410 preferably includes graphics hardware for performing bit-block transfers (bit-blits) as well as other graphical operations in order to display a graphical user interface (GUI) on the television. The GUI may include menus, selectable controls, and the like, and may be displayed separately or simultaneously with television content.

The A/V controller 410 may be coupled to an RF output 412, such as a cable television “F” connector. In such an embodiment, the A/V controller 410 includes a remodulator for generating a modulated television signal on a particular channel, typically channel 3 or 4. Alternatively, the AN controller 410 may be coupled to a composite (RCA-type) video output 414, as well as left and right (stereo) audio outputs 416, 418. Of course, other types of outputs may be provided, such as S-Video, SPDIF, etc.

The STB 102 may also include a central processing unit (CPU) 420, such as a microprocessor, digital signal processor (DSP), or the like. The CPU 420 controls the operation of the STB 102, including the various components thereof.

The CPU 420 executes software programs stored in a memory 421 to perform various tasks, such as displaying a GUI, processing user commands, managing a protocol stack (e.g., TCP/IP) for network communication, and the like. Although not specifically illustrated, those skilled in the art will recognize that the CPU 420 may be coupled to the decoder 408 to allow the CPU 420 to notify the decoder 408 concerning the format of the media stream to decode, e.g. MPEG-2 or MPEG-4. The CPU 420 processes remote control commands which are received by way of the command receiver 212.

The STB 102 may also include a modem device 422, coupled to the CPU 420. The modem device 422 may conform, for example, to the DOCSIS (Data Over Cable Service Interface Specification) or DAVIC (Digital Audio-Visual Council) cable modem standards, although other types of modems are contemplated. The modem device 422 demodulates an analog signal received from the broadband cable network to create a digital signal usable by other components of the STB 102. Likewise, the modem device 422 modulates a digital signal to create an analog signal for transmission to the broadband cable network. While the modem device 422 is illustrated as being disposed within STB 102, an external modem device 124 may be provided in other embodiments. The STB 102 may also include a splitter 424 for directing signals received from the broadband cable network to both the video tuner 404 and the modem device 422.

The STB 102 depicted in FIG. 4 includes a stream selector 426 which selects between media streams from multiple sources, e.g., from a cable television source via the video tuner 404 and from an IP (internet protocol) source via the modem device 422. The selected digital media stream is then passed to the decoder 408 for hardware decoding. In one embodiment, the selection of media streams by the stream selector 426 is controlled by the CPU 420.

In one implementation, the stream selector 426 is a multiplexer having a select line coupled to the CPU 420. The stream selector 426 may also be embodied as a combination of logic gates in an integrated circuit or the like. Alternatively, the stream selector 426 may include analog components. The stream selector 426 may also be implemented as a bus controlled by the CPU 420 with associated programming.

As an example, suppose a user desires to view a signal containing a media stream received from an IP source. The splitter 426 passes the signal to the modem device 422. The modem device 422 receives and demodulates the signal into a series of IP packets, from which the CPU 420 extracts a media stream. The CPU 420 passes the media stream to the stream selector 426, and signals the stream selector 426 (via a select line) to pass the media stream to the decoder 408.

Alternatively, suppose a user wishes to view a signal containing a media stream from a cable television source. The splitter 424 passes the signal to the video tuner 404 and demodulator/demultiplexer 406, where the digital media stream is selectively extracted from the signal. In this case, the CPU 420 signals the stream selector 426 to pass the media stream to the decoder 408.

Thus, the stream selector 426 allows the decoder 408 to selectively decode streams from multiple sources, such as cable television and IP sources. This results in higher frame rates for IP streams and substantially reduces the processing burden on the CPU 420, allowing the CPU 420 to perform other desirable tasks.

In the embodiment shown in FIG. 4, a fixed storage system 302, such as a hard disk drive, is in communication with the demodulator/demultiplexer 406 and the CPU 420 and for storage and retrieval of digital media streams obtained from cable television and IP source. The fixed storage system 302 may be coupled to the aforementioned components via a storage interface 428. The fixed storage system 302 may be used to provide personal video recording (PVR) functionality, such as scheduled recording of television programs, automatic recording of television programs based on specified and observed user preferences, pausing (buffering) live video, and the like. A stored digital media stream may be retrieved from the fixed storage system 302 by the storage interface 428 and sent to the stream selector 426 for decoding by the decoder 408. Unfortunately, the finite amount of storage available on such a fixed storage system 302 will often become full when it is used to store hours of digital video programming.

Hence, in accordance with an embodiment of the invention, a removable storage system 304, such as a CD or DVD burner, is in communication with the demodulator/demultiplexer 406 and the CPU 420 and for storage and retrieval of digital media streams obtained from cable television and IP source. The removable storage system 304 may be coupled to the aforementioned components via a storage interface 430 (which may be separate from or combined with storage interface 428). A stored digital media stream may be retrieved from the removable storage system 304 by the storage interface 428 and sent to the stream selector 426 for decoding by the decoder 408. The removable storage system 304 may be used to provide unlimited capacity to capture and recording of digital video, digital audio, and/or digital data for personal use. By using a removable storage system 304, the storage capacity of the STB 102 becomes in effect unlimited because additional removable media may be used when more capacity is needed.

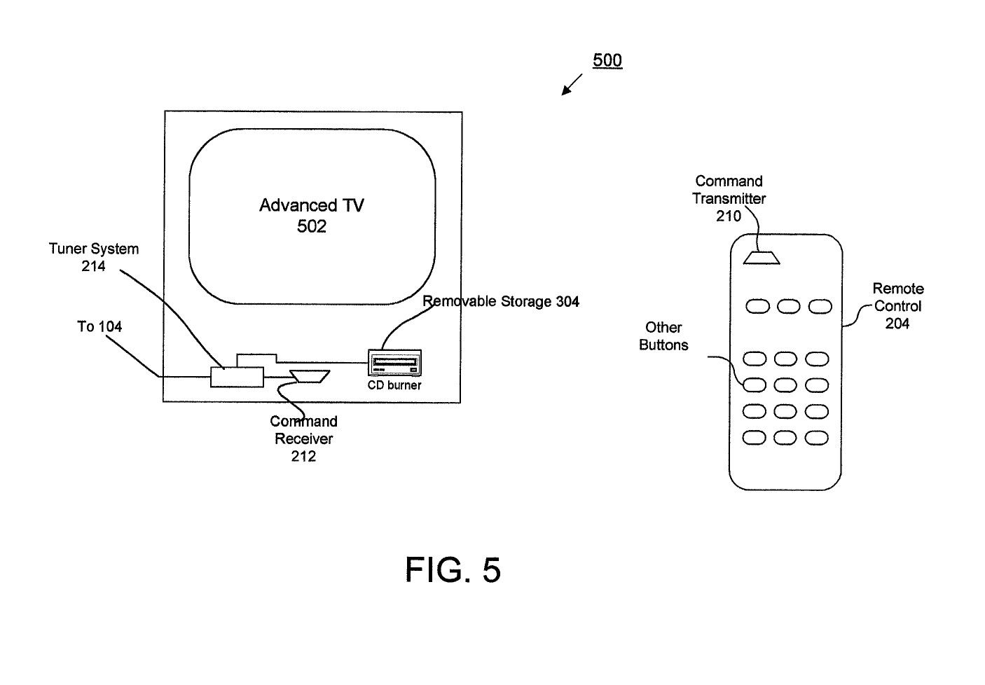

Referring now to FIG. 5, there is shown a second interactive television client system 500 in accordance with an embodiment of the invention. The client system 500 includes an advanced television 502 that incorporates the functionality typically found in an advanced set top box. Such an advanced TV device 502 may include a tuner system 214 to directly receive and process TV signals received from a headend 104 or other broadcast center of a video casting network.

A remote control 204 may be used to input commands to control the advanced TV 502. The remote control 204 may communicate with the advanced TV 502 using conventional techniques to adjust, for example, the volume of the television, the displayed channel, and the like. Such communication may occur, for example, by way of control codes being transmitted from a command transmitter 210 on the remote 204 to a command receiver 212 within the advanced TV 502. The transmitter 210 and receiver 212 may comprise, for example, infrared or radio frequency communication devices.

In accordance with an embodiment of the invention, the advanced TV 502 comprises an integrated removable digital storage system 304. The removable digital storage system 304 may comprise a compact disc (CD) “burner” that enables data to be written onto CDs. The CD burner may provide write-once and/or rewritable capabilities. Alternatively, the removable digital storage system 304 may comprise a digital video disc (DVD) burner that enables data to be written onto DVDs. The DVD burner may also provide write-once and/or rewritable capabilities. In one embodiment, the removable digital storage system 304 may comprise a combination drive that includes both CD and DVD capabilities. Other removable digital storage systems may also be used. The integration of the removable digital storage system 304 into the advanced TV 502 is illustrated in FIG. 5.

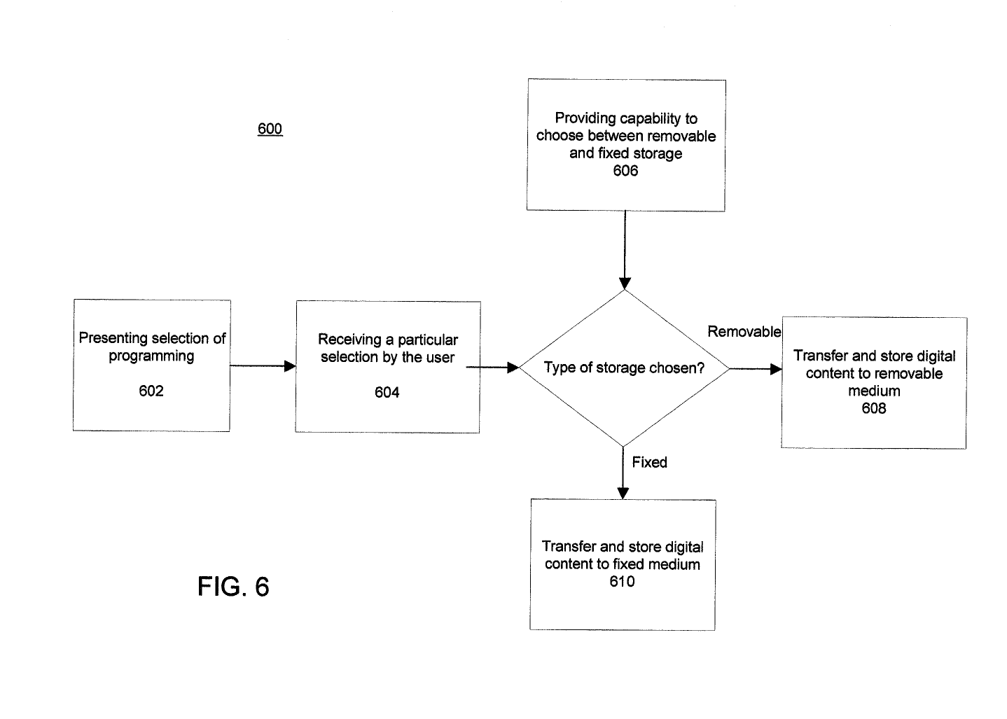

Referring to FIG. 6, there is shown a flow diagram of a method 600 for capturing and storing digital content from a video casting system in accordance with the invention. The method 600 shown includes five steps.

The first step 602 comprises presenting a user with a selection of programming from the video casting system. The presentation may occur, in one embodiment, by way of a user interface (UI) to an electronic program guide to broadcast TV. In another embodiment, the presentation may occur by way of a menu or other user interface for a service such as pay-per-view, video on-demand, or near video on-demand.

Subsequently, the second step 604 comprises receiving a particular selection by the user. The particular selection would be from among the selection of programming presented to the user. The particular selection may comprise a broadcast TV program. Alternatively, it may comprise a movie or other program from a pay-per-view, video on-demand, or near video on-demand service. It may also comprise a streaming video or audio clip, a song or album (audio), a music video, or other data.

The third step 606 comprises providing the user with capability to chose between removable and fixed storage options. This step 606 may be implemented to be after the first 602 and second 604 steps. In that case, the choice may be presented to the user as an inquiry via a “dialog box” or other UI mechanism. However, this step 606 may also be implemented to be before or parallel to those steps. For example, the user may choose to store particular types of content on the removable digital storage and other types of content on the fixed storage. Default settings may also be provided, and the user may choose to accept those default settings.

In a fourth step 608, if removable storage was chosen (either actively or by default), then the digital content (whether video, audio, or other data) is transferred to and stored via the removable digital storage drive to a removable medium. In one embodiment, a format converter may use a CODEC (compression-decompression algorithm) to convert the digital content from one form to another. For example, the format converter may convert streaming audio or WAV files into compressed digital formats. As described above, the removable medium may be a CD, a DVD, or other form of removable media, depending on the capabilities of the removable digital storage drive. In some cases, the user may be asked to name the file in which the digital content is to be stored.

In one embodiment, an “image” (i.e. a copy) of the digital content to be burned is temporarily stored by a relatively fast fixed storage drive. This image is then used as a source by the removable storage drive to facilitate the relatively slow burning of the content onto the removable medium.

In a fifth step 610, if fixed storage was chosen (either actively or by default), then the digital content (whether video, audio, or other data) is transferred to and stored via the fixed storage drive to a fixed medium. As described above, the fixed medium may comprise, for example, a magnetic hard drive disk. Again, in some cases, the user may be asked to name the file in which the digital content is to be stored.

The present invention overcomes the finite storage limitations of conventional systems and provides a user with much greater flexibility in managing the increasingly massive amount of content and data being received by way of interactive TV services. It also enables a user to view digital content on devices other than the one TV in a home that may be capable of receiving the content. For example, the content may be stored digitally onto a writable DVD and viewed on a second TV that has a DVD player but is not capable of receiving the content directly from the interactive TV service. As another example, music may be stored digitally to a CD and played on a car CD player, on a mobile CD playing device, or on a stereo system that is not capable of receiving the content directly from the interactive TV service.

The above description of illustrated embodiments of the invention is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the claims. Rather, the scope of the invention is to be determined by the following claims, which are to be construed in accordance with established doctrines of claim interpretation.

What is claimed is:

1. An interactive television client device for receiving channels from a video casting network, the client device comprising:
a microcontroller configured to control the operation of the client device so as to coordinate the capture and storage of the digital data
a tuner system under control of the microcontroller, wherein said tuner system is configured to tune to a channel of the video casting network;
an extraction system for extracting digital data from the channel;
a command receiver coupled to the microcontroller, wherein said command receiver is configured to receive commands from a remote control device; and
a removable digital storage system coupled to the microcontroller and to the tuner system, wherein said removable digital storage system is configured to store the digital data on a removable digital storage medium.

2. The client device of claim 1, further comprising:
a conditional access system coupled to the tuner system for restricting the channels accessible by the device to authorized channels only.

3. The client device of claim 1, further comprising:
a copyright management system coupled to the removable digital storage system for restricting the digital data storable onto the removable digital storage medium.

4. The client device of claim 1, wherein the tuner system comprises:
a digital tuner configured to tune to a digital channel of the video casting network.

5. The client device of claim 4,
wherein the tuner system further comprises an analog tuner system configured to tune to an analog channel of the video casting network, and
wherein the extracting system comprises an encoder for converting the analog signal to digital data.

6. The client device of claim 1, further comprising:
a fixed storage system coupled to the microcontroller and to the digital tuner system, wherein said removable storage system is configured to store the digital data on a fixed medium; and
a mechanism implemented in part using software to provide a user with a choice between storing the digital data on the removable medium or on the fixed medium,
wherein a copy of the digital data is temporarily stored by the fixed storage system, and
wherein the copy is used as a source by the removable digital storage system to store the digital data onto the removable medium.

7. The client device of claim 1, wherein said channel comprises a channel type from a group of channel types including a TV channel and an IP channel.

8. The client device of claim 1, wherein the digital data comprises compressed digital video.

9. The client device of claim 1, wherein the digital data comprises compressed digital audio.

10. The client device of claim 1, wherein the digital data comprises a form of streaming media.

11. The client device of claim 10, further comprising:
a format converter for converting a first form of digital data to a second form of digital data,
wherein the streaming media is compressed using the format converter prior to being stored on the removable storage medium.

12. The client device of claim 9,
wherein the removable storage system comprises a CD burner, and
wherein the compressed digital audio comprises files formatted in accordance with MP3.

13. The client device of claim 8, wherein the removable storage system comprises a DVD burner and wherein the compressed digital video comprises files formatted in accordance with an MPEG standard.

14. A video casting system for distributing content, including video, audio, and other data, to client devices, the video casting system comprising:
a broadcast center for gathering content and distributing the content;
a plurality of set top boxes for receiving the content from the broadcast center; and
removable storage systems integrated into the set top boxes for storing the content onto removable digital storage media.

15. The video casting system of claim 13, further comprising:
conditional access systems integrated into the set top boxes for restricting the content viewable to authorized content.

16. The video casting system of claim 14, further comprising:
fixed storage systems integrated into the set top boxes for storing the digital content onto fixed media; and
a mechanism implemented in part using software to provide users with a choice between storing the digital content on the removable media or on the fixed media.

17. The video casting system of claim 16, wherein (a) the video casting system comprises a cable network, (b) the broadcast center also gathers analog content and distributes the analog content, and (c) the plurality of set top boxes also receives the analog content from the broadcast center.

18. The video casting system of claim 15, wherein the video casting system further comprises:
an encoder for converting the analog content to additional digital content.

19. The video casting system of claim 14,
wherein the video casting system comprises a satellite broadcast network, and
wherein the content comprises compressed digital video.

20. A method for overcoming finite storage limitations in conventional interactive TV systems, the method comprising:
presenting a user with a selection of programming from the interactive television system;
receiving a particular selection by the user from among the selection of programming presented to the user;
providing the user with capability to store the particular selection on a removable digital storage medium; and
if the user chooses to store the particular selection on the removable digital storage medium, then using a digital storage drive integrated into an interactive TV client device to store the particular selection onto the removable digital storage medium.

21. The method of claim 20, further comprising:
applying conditional access to restrict the programming available to authorized programming.

22. The method of claim 20, further comprising:
providing the user with capability to store the particular selection on a fixed storage medium; and
if the user chooses to store the particular selection on the fixed storage medium, then using a fixed storage drive integrated into an interactive TV client device to store the particular selection onto the fixed storage medium.

23. The method of claim 22, wherein the fixed storage drive comprises a hard disk of limited storage space and the removable storage drive comprises a CD burner.

24. The method of claim 22, wherein the fixed storage drive comprises a hard disk of limited storage space and the removable storage drive comprises a DVD burner.

25. An interactive television client device for receiving channels from a video casting network, the client device comprising:
means for controlling the operation of the client device so as to coordinate the capture and storage of the digital data;
means for applying conditional access to restrict the channels available to authorized channels;
means for tuning to a channel of the video casting network of the interactive television service;
means for extracting digital data from the channel;
means for receiving commands from a remote control device; and
means integrated into the client device for storing the digital data on a removable medium.

26. A video casting system for distributing analog and digital content, including analog video, digital video, digital audio, and other data, to client devices, the video casting system comprising:
centralized broadcasting means for gathering the analog and digital content and distributing the analog and digital content;
distributed client means for receiving the analog and digital content from the centralized broadcasting means; and
removable storage means integrated into the distributed client means for storing the digital content onto removable storage media.

27. An interactive television client device for receiving channels from a video casting network, the client device comprising:
a microcontroller configured to control the operation of the client device so as to coordinate the capture and storage of the digital data;
a tuner system under control of the microcontroller, wherein said tuner system is configured to tune to a channel of the video casting network of the interactive television service;
a conditional access system coupled to the tuner system for restricting the channels accessible by the device to authorized channels only;
an extraction system for extracting digital data from the channel;
a command receiver coupled to the microcontroller, wherein said command receiver is configured to receive commands from a remote control device;
a fixed storage system coupled to the microcontroller and to the digital tuner system, wherein said removable storage system is configured to store the digital data on a fixed medium; and
a removable storage system coupled to the microcontroller and to the extraction system, wherein said removable storage system is configured to store an image of the digital data temporarily on the fixed medium and then to use the image to store the digital data on a removable medium;
a mechanism implemented in part using software to provide a user with a choice between storing the digital data on the removable medium or on the fixed medium,
wherein said channel comprises a channel type from a group of channel types including a TV channel and an internet protocol source,
wherein the digital data comprises a type of digital data from the group of types including compressed digital video and compressed digital audio, and
wherein the removable storage system comprises a device from the group of devices including a CD burner, a DVD burner and a combined CD/DVD burner.

28. The client device of claim 27 further comprising:
a memory configured to include a jukebox module,
wherein the jukebox module customizes a compilation of video and/or music from the digital data for storage onto the removable medium.

29. An video casting system for distributing content, including digital video, digital audio, and other data, to client devices, the video casting system comprising:
a broadcast center for gathering content and distributing the content;
a plurality of set top boxes for receiving the content from the digital broadcast center;
conditional access systems integrated into the set top boxes for restricting the content available to authorized content only;
extraction systems for extracting digital data from the content;
removable storage systems integrated into the set top boxes for storing the digital data onto removable storage media;
fixed storage systems integrated into the set top boxes for storing the digital data onto fixed media; and
a mechanism implemented in part using software to provide users with a choice between storing the digital data on the removable media or on the fixed media,
wherein the video casting system comprises a network from the group of networks including a cable network and a satellite broadcasting network.
